(19) United States
(12) Patent Application Publication
(10) Pub. No.: US 2008/0168107 A1
(43) Pub. Date: Jul. 10, 2008

(54) MedOmniView

(75) Inventors: Shridhar Parvatikar, Cranbury, NJ (US); Vijaykiran Bhagwat, Solapur (IN); Vishnu Enjapoori, East Windsor, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 11/958,662

(22) Filed: Dec. 18, 2007

Related U.S. Application Data
(60) Provisional application No. 60/883,904, filed on Jan. 8, 2007.

(51) Int. Cl. G06F 7/00; G06F 15/16

(52) U.S. Cl. 707/201; 709/207; 707/E17.002; 707/E17.032

(57) ABSTRACT

A system for synchronizing data in a plurality of networks may be provided. Such a system may include an indexer for collecting data coming from an external network and data leaving a local network. The system may further include a querier for querying the local network and viewing data from the plurality of networks; a synchronizer/merger for synchronizing data changes between the local and external network; and a unified index data repository for storing data and data changes of the local network and external network.

### CROSS-REFERENCE TO RELATED CASE

This is a U.S. non-provisional application of U.S. provisional patent application Ser. No. 60/883,904 filed on Jan. 8, 2007, the entire disclosure of which is incorporated herein by reference.

### TECHNICAL FIELD

The technical field of the present invention relates to a system which may handle data of different standards and/or formats. More particularly, the hereinafter described system may synchronize data in a plurality of networks, such as for example metadata in a network for medical data.

### BACKGROUND

In systems comprising a plurality of networks, different data formats may exist. Data may be generated and stored in, for example, a healthcare enterprise network system. An example hereof is shown in FIG. 1. This data may come from multiple data sources. The data from one source may be in a different format than that of another source. Here the network system comprising a plurality of networks comprises a view of a unified data cloud 103. Different components, such as for example servers such as RIS 101, MR scanners 102, reading workplaces 104, processing workplaces 105, LINAC 106, and servers such as PACS 107, are examples of components processing data formats within the network system. Healthcare enterprises may generate data of different formats complying with different industry standards, such as for example DICOM, HL7, IHE, CDA, etc. Apart from these there might be data generated which does not adhere to any of the established standards. Additionally, data may exist in the form of PDF, AVI, Word or any other kind of files. A problem arises when trying to provide a snapshot or a summary view of different kinds of data to the user at any point of time and available anywhere within the network, because of the many different data formats within the network. The example shown in FIG. 1 only allows display of data of a particular format on a particular system.

Available solutions in the market address particular segments of the problem of the system in question and adhere to standards defined in those areas. In other words, systems conforming to HL7 or DICOM can not talk to each other, let alone providing a single point of access and a consolidated view of, for example, the same patient centric data.

Because of the current rigidity of the standards being practiced, it is not possible for two systems conforming to different standards to talk to each other, without help of a mediating external broker application. Hence it is extremely difficult to provide a single point of access for all kinds of data available at a system such as for example a healthcare provider.

Mediator solutions currently available are limited in scope as they need to be created, configured, maintained/updated for each individual connection points. Furthermore, in most cases such solutions are not reusable. An example hereof is a DICOM node transferring data via an OpenLink/Mitra Broker to a server, such as, for example, a RIS. Such a Mediator/OpenLink provides a system with a limited scope of use. The system needs to be created, configured, maintained/updated for each individual connection point and in most cases is not reusable. Furthermore, it can not be used with non-standard data formats.

In view of the prior art discussed above, there is a need to provide a system for synchronizing data in a plurality of networks. Hereby, a system may provide a unified data view at all locations, at all time, irrespective of the connectivity issues of multiple data sources and data in different formats, such as DICOM, HL7, IHE, and/or CDA.

There is further a need to provide a capability of providing a snapshot or a summary view of all kinds of data to the user at any point of time and available anywhere within a system of networks.

There further exists a desire to provide integration of different kind of data format, such as for example medical domain data format, including non-standard data types like Word documents, PDFs, AVI files and to allow indexation and storage thereof.

It is desirable to provide an alternative to systems that need to be created, configured, maintained/updated for each individual connection points and are not reusable. Furthermore, it is desirable to provide an alternative to systems that can not be used with non-standard data types or formats.

### SUMMARY

According to an embodiment, a system for synchronizing data in a plurality of networks may comprise an indexer for collecting data coming from an external network and data leaving a local network; a querier for querying the local network and viewing data from the plurality of networks; a synchronizer/merger for synchronizing data changes between the local and external network; and a unified index data repository for storing data and data changes of the local network and external network.

In further embodiments, the data may comprise metadata. Elements in the metadata may be configurable. Furthermore, the elements in the metadata may comprise at least one of standard data and nonstandard data. Additionally, the metadata storage may be configured as at least one of a relational database, XML, and a flat file system.

In an embodiment, originating data in the external network and local network may comprise at least one of DICOM, HL7, IHE, CDA format or any non-standard format.

In a further embodiment the synchronizer/merger may synchronize data when the external network is in at least one of a connected state and a disconnected state. Additionally, the synchronizer/merger may provide substantially the same data in the local network and external network.

In yet a further embodiment the network with a data change may broadcast the data change.

In further embodiments, the unified index data repository may support at least two networks or a single network. The metadata in the unified index data repository may be configured as hierarchical data.

Embodiments of the system may be scalable.

According to an embodiment, a method for synchronizing data in a plurality of networks may comprise collecting data coming from an external network and data leaving a local network;

querying the local network and viewing data from the plurality of networks; synchronizing data changes between the local and external network; and storing data and data changes of the local network and external network.

In a further embodiment the data may comprise metadata. The metadata may be formatted in a hierarchical order. Additionally, elements in the metadata may be formatted in a hierarchical order. The elements in the hierarchy may comprise at least one of a standard data format and a nonstandard data format.

In a further embodiment the step of synchronizing may further comprise updating local indexes to reflect changes occurring in the external network.

In yet a further embodiment the method may further comprise broadcasting a change in data via the network undergoing the change in data.

At least one of the embodiments provides a system for synchronizing data in a plurality of networks. Hereby, multiple data sources and data in different formats, such as DICOM, HL7, IHE, CDA, may provide unified data view at all locations, at all time, irrespective of the connectivity issues.

At least one of the embodiments provides a snapshot or a summary view of all kinds of data to the user at any point of time and available anywhere within the network.

At least one of the embodiments provides integration of all different kind of data format, such as for example medical domain data format, including non-standard data types like word documents, PDFs, AVI files allowing indexation and storage thereof.

At least one of the embodiments provides an alternative to systems that need to be created, configured, maintained/updated for each individual connection points and are not reusable. Furthermore, at least one of the embodiments provides an alternative to systems that can not be used with non-standard data types or formats.

At least one of the embodiments provides a system for integrating hospital information systems. Data availability from different sources and the possibility to integrate and represent data in a single platform may be provided by embodiments. Embodiments may integrate all different data sets and represent them uniquely at every workstation. A suitable name might be MedOmniView because data may be Omni present for review and research.

Other technical advantages of the present disclosure will be readily apparent to one skilled in the art from the following description and claims. Various embodiments of the present application obtain only a subset of the advantages set forth. No one advantage is critical to the embodiments. Any claimed embodiment may be technically combined with any preceding claimed embodiment(s).

### BRIEF DESCRIPTION OF THE DRAWINGS

The accompanying drawings, which are incorporated in and constitute a part of the specification, illustrate presently preferred embodiments, and together with the general description given above and the detailed description of the preferred embodiments given below, serve to explain, by way of example, the principles of the invention. Similar reference numerals indicate similar items throughout the description.

FIG. 1 shows an example of a unified data cloud according to prior art.

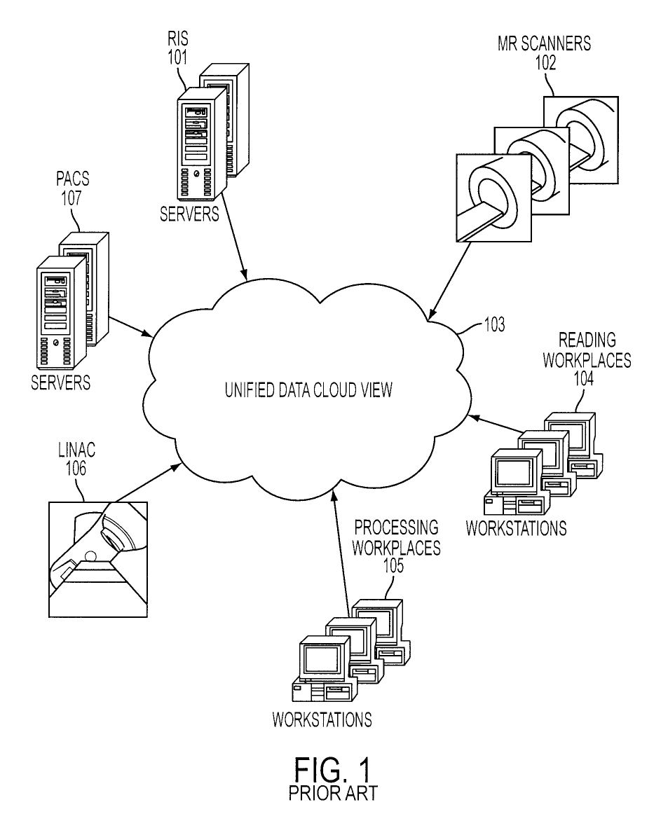

FIG. 2 shows a network of systems according to an embodiment.

FIG. 3 shows a system according to an embodiment.

FIG. 4 shows an indexer according to an embodiment.

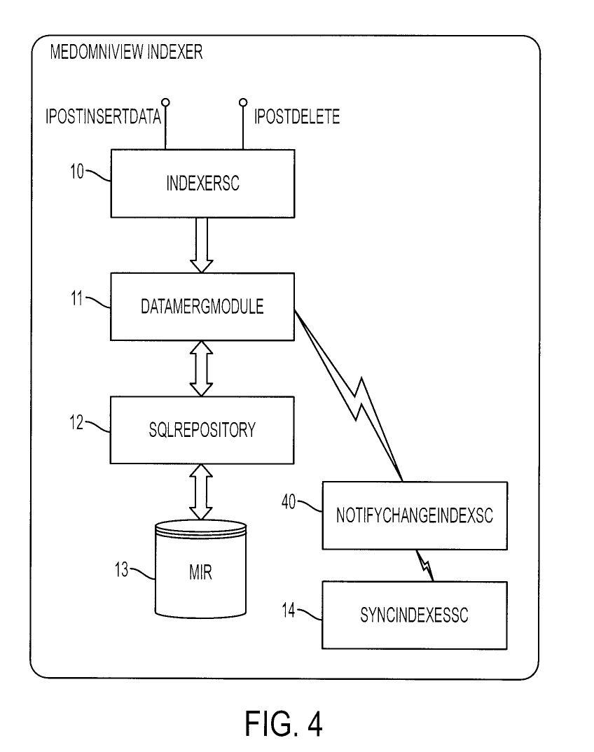

FIG. 5 shows synchronization according to an embodiment.

FIG. 6 shows a schematic embodiment of a query.

FIG. 7 shows an embodiment relating to a local UDR.

FIG. 8 shows an embodiment relating to a centralized UDR.

FIG. 9 shows configured metadata in hierarchy according to an embodiment.

### DETAILED DESCRIPTION

At least one embodiment may provide a system providing unified data view at all locations, at all time, irrespective of connectivity issues. In one embodiment metadata storage may be used. An embodiment may store the metadata from all the different data sources and may provide fast access to all the different data via search through metadata.

At least one embodiment may provide a unified view; a birds-eye-view which can be drilled down to small granular level may be available for the entire network of data islands. The network of data islands will stay connected, synchronize and communicate to each other using the architecture of the embodiments herein described.

At least one embodiment may provide transparent data access. In other words, applications that need to access the data may not need to know where the data is located. Querying the herein described embodiments may provide the complete details along with the location of the data and the availability status.

At least one embodiment may provide data availability status. For example, all the data that may be accessed may provide the status of availability of that data. Embodiments of the current system may be connected to other participating systems and then the status may be shown as available on-line. Data that may be offline may only be viewed, since retrieving may not be possible during offline state.

At least one embodiment may provide information of data location. For example, all data that may be accessed may provide the physical location of the queried data. This physical location (for example the Application Entity title of a remote DICOM PACS node storing the data) may be used by the system to retrieve data. Embodiments may not necessarily provide an interface to retrieve the data. Standard specific retrieval mechanisms may be used.

At least one embodiment may provide synchronization of metadata, with or without network connectivity. For example, whenever data either enters or leaves a network of data islands, the system may not only update its own metadata, but may also inform all other participating, connected systems about the change. Each of these systems may be listening to these changes and may hence update themselves. If one of the systems is off the network and may not communicate with other systems, it may do so once it gets back on to the network. There may be a defined synchronization handshake mechanism, by which an offline system becoming online will get re-synchronized with other systems.

At least one embodiment may provide centralized metadata storage or individualized node based metadata storage. For example, metadata storage for embodiments of the system may be configured as either a centralized repository or an individualized repositories sitting on each of the participating systems.

At least one embodiment may provide unified configurable data. Metadata presenting a unified view may be highly configurable. The data hierarchy and contents of the hierarchy and the sources of those data elements (DICOM, HL7) may be configurable. For example, data may be configured as either Patient relating to Study relating to Series, or as in case of experimental research lab requirements as Project relating to Experiment relating to Study relating to Series. Each of these levels may have any permutation of data elements into it. For example, an experiment can have PDF and AVI files attached along with a particular strain of mouse experimentation images.

At least one embodiment may provide fast query responses if only metadata may be searched. As embodiments may store only the metadata in a local system, the query response may be much faster than, for example the currently available PACS, RIS or any IS solutions. Furthermore, in most cases where the metadata is stored in relational databases, the searches may be even faster. In embodiments, metadata storages may be configurable and may be, for example in the form of a relational database, XML, or a flat file system.

At least one embodiment may provide a highly scalable system. For example, embodiments may be highly scalable from, for example a small clinic to a large hospital enterprise. In case of a small clinical usage, metadata storage may be in the form of inexpensive xml files, or in the form of freely available small scale relational databases, like for example MSDE or SQL Express. In case of larger enterprises the meta storage may be configured to be into a full blown, commercially available relational database management solution, like for example SQL Server or Oracle.

At least one embodiment may provide a low footprint. In other word, as embodiments may only deal with metadata, the systems resources, such as data storage requirements, may be very low.

At least one embodiment may provide a system that may work with a single user or a multiple of clients. Embodiments may be configured to work as either a standalone solution or to a solution with ‘n’ numbers of interconnected participants.

At least one embodiment may provide an information system that may be pluggable/extensible. For example, an existing or new data generating systems may be plugged in. An example hereof may be to plug in, for example DICOM, HL7, and/or non standard complaint data that may participate in an aggregated embodiment. For each new different standard based data sources a new plug-in module may be written. Hereby a data source may be seamlessly integrated in to an existing embodiment of the system.

At least one embodiment may provide minimal hardware requirement. For example, an embodiment may run on a standard PC using Windows XP. The underlying metadata storage may dictate hardware and OS needs. Enterprise solutions needing a RDBMS, like for example Oracle or SQL server, may have their own hardware requirement.

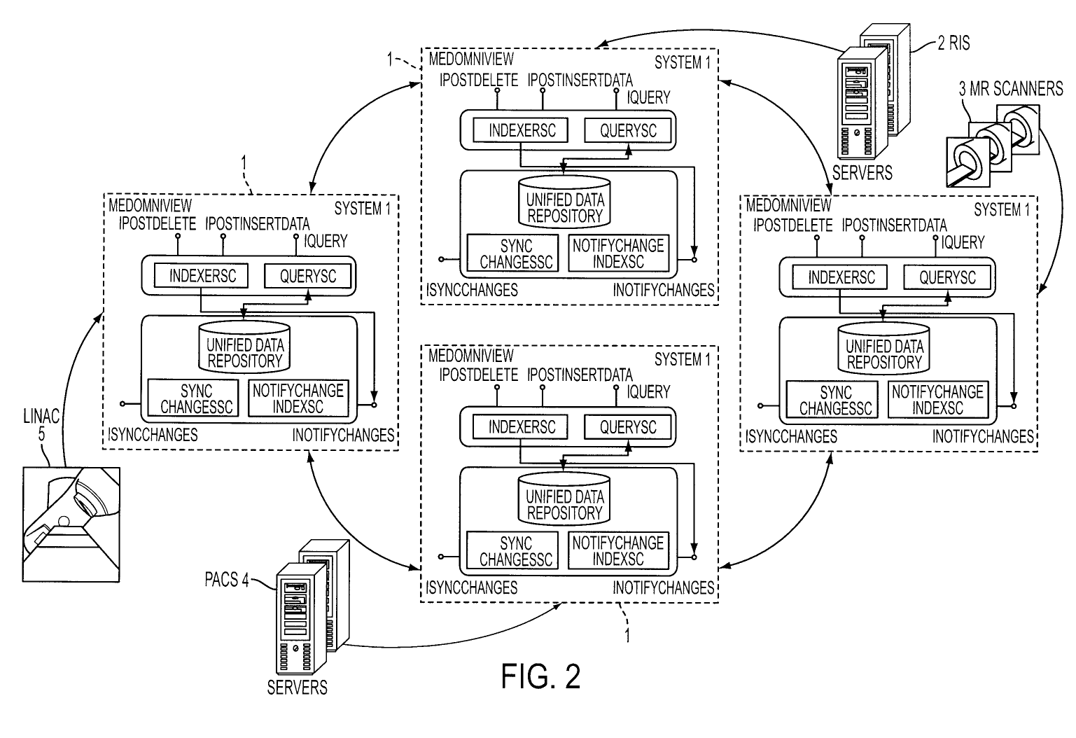

FIG. 2 shows a system according to an embodiment. In this embodiment each system 1 may be interfacing with other systems 1 contributing to a unified data view. Each system 1 may be listening into other attached systems 1 to detect each piece of data coming into or going out of the system. The systems 1 may be interfacing different components, such as for example servers such as RIS 2 or PACS 4, or MR scanners 3, or a medical device, such as a LINAC 5. Each of the entry and exit of data into each system 1 may trigger an indexing and in turn a synchronization mechanism described in later sections. All the systems 1 participating in the unified data view may be having an exact same view of all the data in the system and each of the systems 1 will be capable of providing an extensive query mechanism to query every bit of data configured to participate in the unified view.

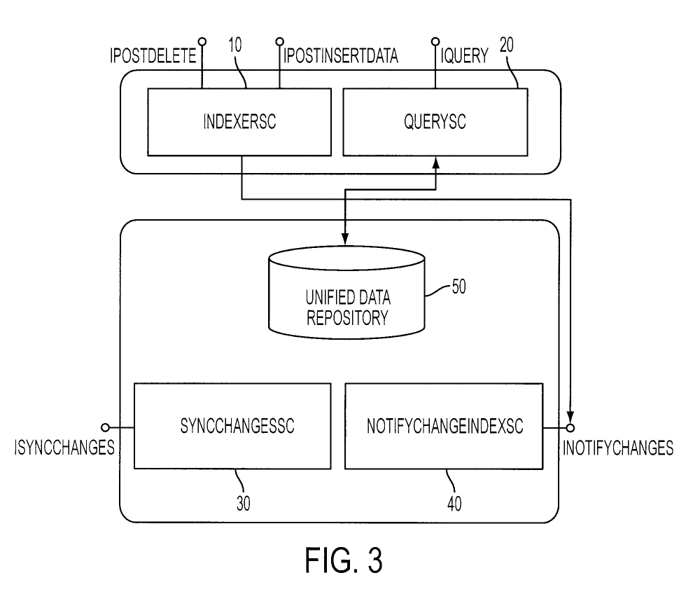

FIG. 3 shows a system 1 according to an embodiment. The system may comprise an Indexer Service Component 10 (IndexerSC); a Query Service Component 20 (QuerySC); a Synchronization Service Component 30 (SyncChangesSC); a Notify Changed Indexes Service Component 40 (NotifyChangeIndexSC); and a Unified Index Data Repository 50 (a relational database or a flat file holding the unified data indexes).

Turning to the working manner of the indexing, indexing may be a process of metadata collection for the data that is coming in and going out of the entire connected data islands. This metadata collection may comprise two parts.

Firstly, collecting metadata that may be added to or removed from the current system. This might, for example, be the data coming in from, for example, a scanner or a technician removing the superfluous unwanted data.

Secondly, collecting data that may have entered or exited an interconnected system. This process is the synchronization process and is described in more detail hereinafter.

In one embodiment, data that is generated by the components, such as for example a scanner, laboratory test results, or a monitoring devices, may trigger an event or the IndexerSC 10 may be listening in to those data sources for any new data being generated. This trigger/listen mode may result in IPostInsertData being invoked. This in turn may result in metadata being retrieved and stored in the UDR (Unified Data Repository). If any data is being deleted from the system by users or by any other means, a similar trigger/listen mechanism may result in the metadata being removed from the UDR. Additionally if only a part of hierarchal data is being added or removed, DataMergerModule 11 may take care of adding or removing metadata optimally, keeping integrity of the remaining dataset.

The DataMergerModule 11 may interact with a data source, for example, SqlRepository 12, which in turn may interact with a MIR 13. According to various embodiments the data source can be any kind of repository. Data transfer may occur between a SyncINdexesSC 14 and the NotifyChangeIndexSC 40.

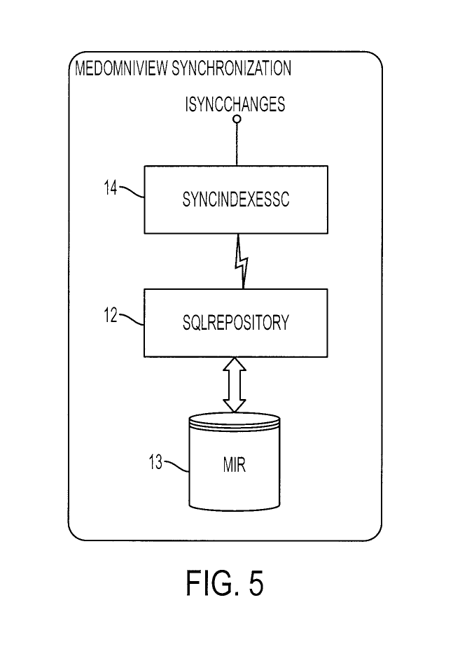

Turning to the working manner of the synchronization, notification, and/or merge between each system 1, the system 1 may not only be updating metadata indexes for the data flow within a local system, but may also be responding to data flowing in and out of other systems. This process of updating local indexes to reflect changes happening in other interconnected systems is herein called the Synchronization/Merge process. The main functional modules making up this Synchronization/Merge part of the system 1 are shown in FIG. 5. Here, data transfer may occur between the SyncINdexesSC 14 and the SqlRepository 12, which in turn may interact with the MIR 13.

In one embodiment, when an indexing is triggered into the local system it may result in notifications being sent to all the directly connected systems 1. Upon receiving updates of data changes in the connected remote systems 1, each system 1 will update its own metadata store in the UDR 50. Only the systems which are directly receiving or removing the data may be notifying the interconnected systems, thus avoiding multiple and recursive notifications.

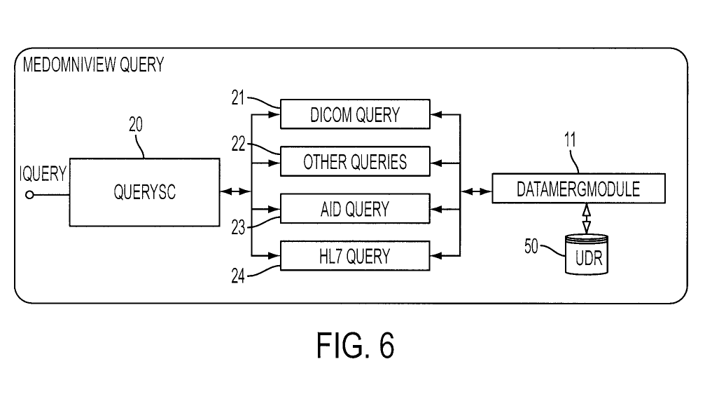

Turning to the working manner of the query, a schematic embodiment thereof is shown in FIG. 6. The query may search for an attribute in the indexed information, for example in metadata. Metadata may be maintained in a relational database (or other format) and searching for any particular indexed information may be relatively simple and fast. Along with the query results, location of the data may also be returned. This may be helpful in the sense that actual data location can help to decide if the data needs to be imported before any particular action, diagnosis, and/or processing may be done.

In an embodiment, an IQuery interface may be used to query the UDR 50. Getting a query results may be facilitated by each system 1 being provided with this kind of interface. An example of query inputs may be a key to key value pairs. In the embodiment shown in FIG. 6, the QuerySC 20 may serve a DICOM query 21, other queries 22, an AID query 23, and/or a HL7 query. Depending on the query outcome, DataMergerModule 11 may interact with the UDR 50.

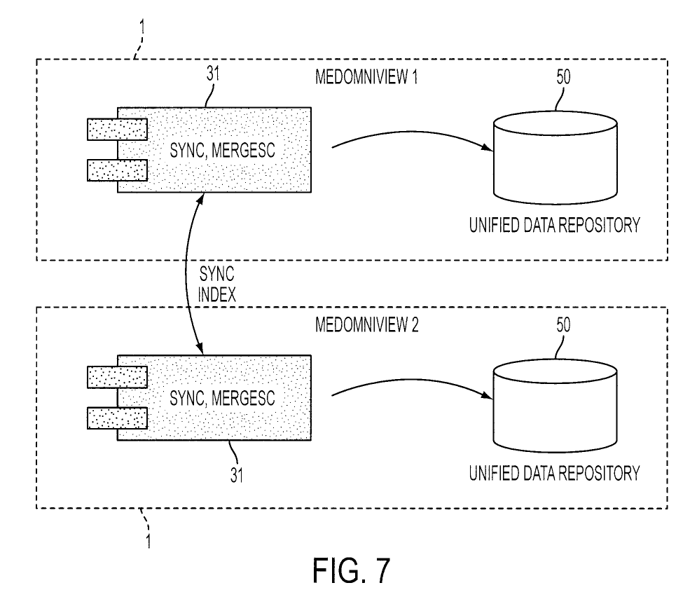

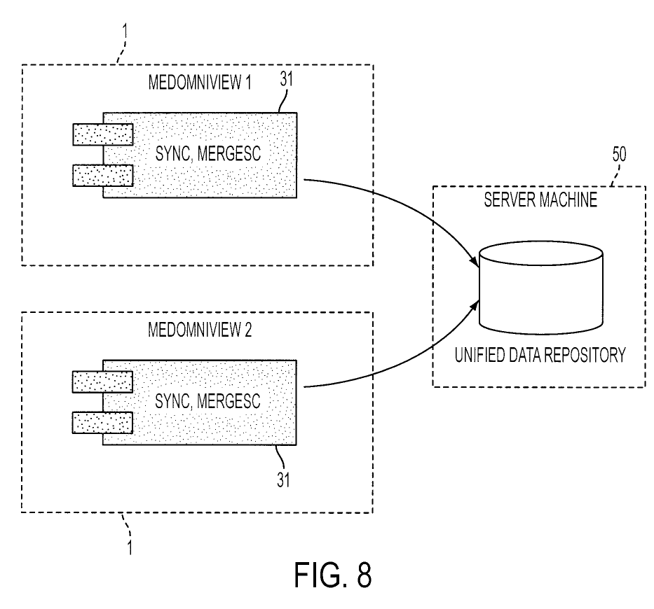

Turning to the configuration of the system, there may be two kinds of configurations. These two kinds of configurations are schematically described in FIGS. 7 and 8, respectively. Where FIG. 7 relates to a local UDR 50 and FIG. 8 relates to a centralized UDR 50. Key features of these two types of configuration have been discussed above.

FIG. 7 shows an embodiment relating to a local UDR 50. Here two systems 1 are shown, one in each dashed-lined box. Synchronization may occur between each of the Synchronization/MergerSC components 31 of the two systems 1 and the respective UDR 50 may be updated.

FIG. 8 shows an embodiment relating to a centralized UDR 50. Here two systems 1 are shown, one in each dashed-lined box. Each Synchronization/MergerSC 31 component of the two systems 1 may access the UDR 50 at a central server.

Turning to the configuration of the metadata, the metadata in the UDR itself can be configured as a hierarchical data. All the elements in the hierarchy are configurable. The elements within the hierarchy can consist of any combination of the standard data and non standard data.

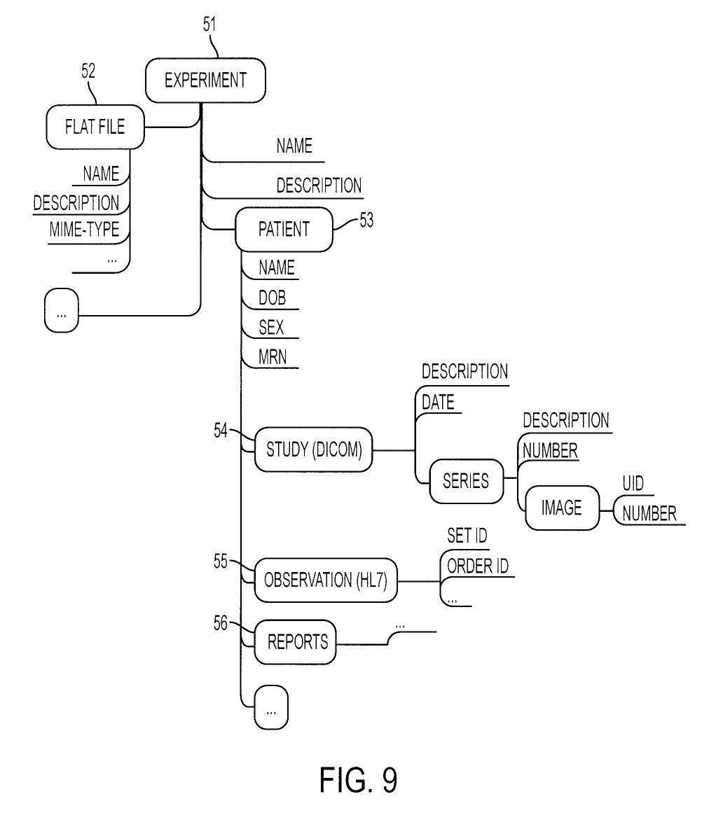

FIG. 9 shows configured metadata according to an embodiment. The metadata presenting a unified view may be configurable. The data hierarchy and contents of the hierarchy and the sources of those data elements may be configurable. For example, data may be configured as shown in the example in FIG. 9, where an experiment 51 may contain a flat file of data 52, patient data 53, study (DICOM) data 54, observation (HL7) data 55, reports 56, etc. Each may in turn relate to one or more further set(s) of data as shown in the FIG. 9. Each of these levels may have any permutation of data elements into it. For example, an experiment can have PDF and AVI files attached along with, for example a particular strain of mouse experimentation images.

At least one embodiment of the system may present all configured medical data in a one place dynamic view. This view may be available at each system in the network. Data may be present anywhere/everywhere irrespective of any connectivity issues. Furthermore, more systems can be added or removed to the network of systems, allowing for a scalable network of systems. At least one embodiment may synchronize between online/offline systems without user intervention. In embodiments centralized metadata storage or individual systems could be used for maintaining metadata. At least one embodiment of the system may provide Query, Insert, Delete, Update services for collaborating information.

At least one embodiment of the system may provide integration of different data in a medical domain. Furthermore, fast data retrieval may be achieved due to the use of metadata search. Fully configurable metadata information, highly scalable system, and data availability with/without network connection are further advantages provided by embodiments of the system. Data integration using metadata storage may be used for any other field, such as for example legal, biologic, chemical, mechanical, or electrical fields.

At least one embodiment of the system may provide metadata maintenance and integration of different data types, such as for example HL7, DICOM, non-standardized data types.

The system discussed above allows for synchronizing data in a plurality of networks. The invention, therefore, is well adapted to carry out the objects and attain the ends and advantages mentioned, as well as others inherent therein. While the invention has been described and is defined by reference to particular preferred embodiments of the invention, such references do not imply a limitation on the invention, and no such limitation is to be inferred. The invention is capable of considerable modification, alteration, and equivalents in form and function, as will occur to those ordinarily skilled in the pertinent arts. The described preferred embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A system for synchronizing data in a plurality of networks, comprising:
an indexer for collecting data coming from an external network and data leaving a local network;
a querier for querying the local network and viewing data from the plurality of networks;
a synchronizer/merger for synchronizing data changes between the local and external network; and
a unified index data repository for storing data and data changes of the local network and external network.

2. The system of claim 1, wherein the data comprises metadata.

3. The system of claim 2, wherein metadata storage is configured as at least one of a relational database, XML, and a flat file system.

4. The system of claim 1, wherein originating data in the external network and local network comprises at least one of DICOM, HL7, IHE and CDA format.

5. The system of claim 1, wherein the synchronizer/merger synchronizes data when the external network is in at least one of a connected state and a disconnected state.

6. The system of claim 5, wherein the synchronizer/merger provides substantially the same data view in the local network and external network.

7. The system of claim 1, wherein the network with a data change broadcasts the data change.

8. The system of claim 1, wherein the unified index data repository supports at least two networks.

9. The system of claim 1, wherein the unified index data repository supports a single or multiple networks.

10. The system of claim 1, wherein the metadata in the unified index data repository is configured as hierarchical data.

11. The system of claim 2, wherein elements in the metadata are configurable.

12. The system of claim 1, wherein the elements in the metadata comprise at least one of standard data and nonstandard data.

13. The system of claim 1, wherein the system is scalable.

14. A method for synchronizing data in a plurality of networks, comprising:
collecting data coming from an external network and data leaving a local network;
querying the local network and viewing data from the plurality of networks;
synchronizing data changes between the local and external network; and
storing data and data changes of the local network and external network.

15. The method of claim 14, wherein the data comprises metadata.

16. The method of claim 15, further comprising:
formatting the metadata in a hierarchical order.

17. The method of claim 16, further comprising:
formatting elements in the metadata in a hierarchical order.

18. The method of claim 17, wherein the elements in the hierarchy comprise at least one of a standard data format and a nonstandard data format.

19. The method of claim 14, wherein the step of synchronizing further comprises updating local indexes to reflect changes occurring in the external network.

20. The method of claim 14, further comprising:
broadcasting a change in data via the network undergoing the change in data.
